(19) United States
(12) Patent Application Publication
(10) Pub. No.: US 2007/0134526 A1
(43) Pub. Date: Jun. 14, 2007

(54) Fuel cell system and water recovery method thereof

(75) Inventors: Yasuhiro Numao, Kanagawa (JP); Yasukazu Iwasaki, Kanagawa (JP); Mitsutaka Abe, Kanagawa (JP)

Correspondence Address: FOLEY AND LARDNER LLP;SUITE 500, 3000 K STREET NW, WASHINGTON, DC, 20007, US

(73) Assignee: Nissan Motor Co., Ltd.

(21) Appl. No.: 10/577,997

(22) PCT Filed: Oct. 28, 2004
(86) PCT No.: PCT/JP04/16356

§ 371 Date: May 3, 2006

(30) Foreign Application Priority Data
Nov. 4, 2003 (JP) 2003-374264

(51) Int. Cl. H01M 8/04

(52) U.S. Cl. 429/22; 429/34; 429/26

(57) ABSTRACT

A fuel cell system comprises a fuel gas supply mechanism (1, 91-97) which supplies a fuel gas, an oxidizing gas supply mechanism (2) which supplies an oxidizing gas, a fuel cell (5) which generates power using the fuel gas supplied from the fuel gas supply mechanism (1, 91-97) and the oxidizing gas supplied from the oxidizing gas supply mechanism (2), and a water recovery device (41, 42) which separates and recovers water contained in exhaust gas from the fuel cell (5), and mixes the recovered water with a water-compatible liquid in the location where the water is separated and recovered.

### TECHNICAL FIELD OF THE INVENTION

This invention relates to a fuel cell which generates power using fuel gas and oxidizing gas, and more particularly to preventing water inside a fuel cell from freezing in low temperature environments.

### BACKGROUND OF THE INVENTION

In a fuel cell system for use in a movable body, in contrast to a stationary fuel cell system, there are times when it is impossible to replenish the water that is required in the system, and hence a system which recovers the water contained in the exhaust gas of the fuel cell stack is required. In a fuel cell system disclosed in JP8-91804A, published by the Japan Patent Office in 1996, a water separator is provided for recovering water contained in the gas that is discharged from a fuel cell stack.

### SUMMARY OF THE INVENTION

In a fuel cell system for a movable body, water must be recovered from the exhaust gas of the fuel cell stack by a water recovery device even when the movable body is located in a subzero environment.

In the prior art described above, however, when the fuel cell system is started up below freezing point, the water may condense and freeze in the interior of the water separator, thus blocking the passages such that water recovery cannot be performed. By warming the water separator using a heater or the like, the fuel cell system can be started up, but in so doing, energy is consumed, and time is required to raise the temperature of the water separator so that an operation can be begun.

It is therefore an object of this invention to prevent water recovered from the exhaust gas of a fuel cell in a fuel cell system from freezing, and to enable water recovery to be continued below freezing point.

In order to achieve the above mentioned object, this invention provides a fuel cell system comprising: a fuel gas supply mechanism which supplies a fuel gas; an oxidizing gas supply mechanism which supplies an oxidizing gas; a fuel cell which generates power using the fuel gas supplied from the fuel gas supply mechanism and the oxidizing gas supplied from the oxidizing gas supply mechanism; and a water recovery device which recovers water contained in an exhaust gas from the fuel cell. The water recovery device includes a liquid introducing mechanism which sprays a water-compatible liquid onto a location where the water is recovered by the water recovery device.

The details as well as other features and advantages of this invention are set forth in the remainder of the specification and are shown in the accompanying drawings.

### BRIEF DESCRIPTION OF THE DRAWINGS

FIG. 1 is a schematic diagram of a fuel cell system according to this invention (first embodiment).

FIG. 2 is a schematic diagram showing the input and output of a controller.

FIG. 3 is a flowchart showing the control content of the controller.

FIG. 4 is similar to FIG. 1, but shows a schematic diagram of a fuel cell system of a second embodiment.

FIG. 5 is similar to FIG. 2, but shows a schematic diagram of the input and output of a controller of the second embodiment.

FIG. 6 is similar to FIG. 3, but shows a flowchart of the control content of the controller of the second embodiment.

### DESCRIPTION OF THE PREFERRED EMBODIMENTS

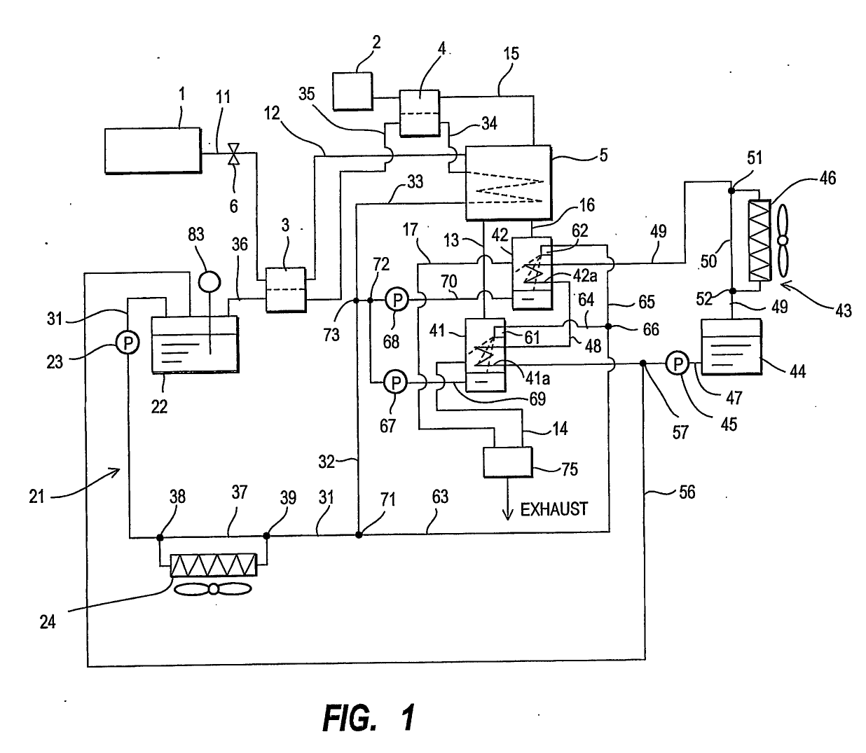

Referring to FIG. 1 of the drawings, a fuel cell system comprises a high-pressure hydrogen tank 1 for supplying hydrogen (fuel gas), a blower 2 for supplying air (oxidizing gas), humidifiers 3, 4, a fuel cell stack 5, a fuel cell stack cooling device 21, a water recovery device constituted mainly by condensers 41, 42 and injectors 61, 62, a condenser cooling device 43, a burner 75 for burning exhaust gas following water recovery, and a controller 81 constituted by one, two, or more microprocessors, RAM, ROM, and an input/output interface.

The hydrogen issued from the high-pressure hydrogen tank 1 passes through a valve 6 and a passage 11, is humidified by the humidifier 3, and is then supplied to the fuel cell stack 5 through a passage 12. The air fed under pressure by the blower 2 is humidified by the humidifier 4, and then supplied to the fuel cell stack 5 through a passage 15. The fuel cell stack 5 generates power by means of an electrochemical reaction.

The fuel cell stack cooling device 21 cools the operative fuel cell stack 5. The fuel cell stack cooling device 21 is constituted by a first cooling water tank 22, a pump 23, a radiator 24, and main passages 31-36. Cooling water that is pumped from the cooling water tank 22 by the pump 23 is led to the radiator 24 via the main passage 31, and cooled by means of heat exchange with outside air. The cooling water that is cooled by the radiator 24 is then led to the fuel cell stack 5 through the main passages 32, 33 to cool the interior of the fuel cell stack 5. Having exited the fuel cell stack 5, the cooling water is returned to the cooling water tank 22 via the main passages 34, 35, 36. A part of the cooling water is used in the humidifiers 4, 3 to humidify the hydrogen and air respectively, whereby water contained in the cooling water is lost. In consideration of the fact that it is sometimes unnecessary to cool the cooling water using the radiator 24, a bypass passage 37 is provided at the radiator 24, and three-way valves 38, 39 are provided at the bifurcation portion and convergence portion of the bypass passage 37 respectively.

The hydrogen (discharged hydrogen) and air (discharged air) that are not used for power generation are led to the condensers 41, 42 through passages 13, 16 respectively. The two condensers 41, 42 serving as the water recovery device are constituted identically, and comprise passages 41a, 42a in their interiors through which the cooling water circulates. The condenser cooling device 43 is constituted by a second cooling water tank 44, a pump 45, a radiator 46, and passages 47, 48, 49. The cooling water in the cooling water tank 44 is pumped by the pump 45, and thus led through the passage 47 to the passage 41a in the interior of one of the condensers 41, and through the passage 48 to the passage 42a in the interior of the other condenser 42. The cooling water then performs heat exchange with the discharged hydrogen and discharged air, thereby cooling the discharged hydrogen and discharged air. As a result of this cooling, water vapor contained in the discharged hydrogen and discharged air condenses to form water and gathers in the bottom of the condensers 41, 42, and hence the water vapor contained in the exhaust gas (discharged hydrogen, discharged air) from the fuel cell stack 5 is recovered as water.

Meanwhile, the condenser cooling water that has been warmed by the heat exchange performed in the condensers 41, 42 is led to the radiator 46 through the passage 49, cooled in the radiator 46, and then returned to the cooling water tank 44. In consideration of the fact that it is sometimes unnecessary to perform cooling using the radiator 46, a bypass passage 50 is provided at the radiator 46, and three-way valves 51, 52 are provided at the bifurcation portion and convergence portion of the bypass passage 50 respectively.

An antifreeze material or antifreeze liquid is mixed into the cooling water stored in the first cooling water tank 22 and second cooling water tank 44 to reduce the melting point of the cooling water inside the cooling water tanks 22, 44 below zero degrees centigrade, which is the melting point of pure water.

The cooling water in the interior of the second cooling water tank 44 is supplied to the first cooling water tank 22 through a flow control valve 57 provided on the bifurcation portion of a passage 56 which bifurcates from the passage 47 which leads out from the cooling water tank 44. As an operation of the fuel cell system continues, the water in the first cooling water tank 22 is lost due to humidification of the hydrogen and air, causing the antifreeze concentration of the cooling water in the cooling water tank 22 to rise. When the antifreeze concentration exceeds a predetermined concentration Ca, the flow control valve 57 is adjusted such that a part of the cooling water in the second cooling water tank 44 is used to refill the first cooling water tank 22. In so doing, the antifreeze concentration of the cooling water in the first cooling water tank 22 is prevented from exceeding the predetermined concentration Ca.

The water vapor in the exhaust gas discharged from the fuel cell stack 5 is cooled by the condenser cooling device 43 to form condensed water. When the ambient temperature of the condensers 41, 42 is below freezing point, the condensed water may freeze in the interior of the condensers 41, 42. Therefore, the injectors 61, 62 (mechanism for introducing a water-compatible liquid) are attached to the condensers 41, 42. Fuel cell stack cooling water is led to the injectors 61, 62 through a bifurcated passage 63 which bifurcates from the main passage 31, and passages 64, 65 which bifurcate from this passage 63. The fuel cell stack cooling water acts as a water-compatible liquid.

More specifically, the fuel cell stack cooling water injected by the injectors 61, 62 is sprayed onto the location at which the water vapor contained in the exhaust gas discharged from the fuel cell stack 5 condenses following cooling by the condenser cooling device 43. The water vapor mixes with the sprayed fuel cell stack cooling water and gathers in the bottom of the condensers 41, 42. Since the sprayed fuel cell stack cooling water contains antifreeze, the melting point of the mixed solution of condensed water and fuel cell stack cooling water falls to a temperature below zero degrees centigrade, which is the melting point of pure water. As a result, condensed water in the interior of the condensers 41, 42 is prevented from freezing even when the ambient temperature of the condensers 41, 42 is below freezing point.

In consideration of the fact that the injectors 61, 62 need only be operated when the ambient temperature of the condensers 41, 42 is low such that there is a possibility of the water vapor contained in the exhaust gas from the fuel cell stack 5 freezing upon condensation in the interior of the condensers 41, 42, a control valve 71 is provided on the bifurcation portion of the main passage 31 so that the flow of fuel cell stack cooling water into the bifurcated passage 63 can be opened and blocked and the flow rate thereof controlled.

The flow distribution of the two injectors 61, 62 is set appropriately according to the flow ratio of the discharged hydrogen and discharged air, and so on. When the passages 64, 65 have the same diameter and the injectors 61, 62 have the same specifications, the flow ratio is regulated by a control valve 66 provided at the bifurcation portion of the passages 64, 65.

The water that is recovered by the condensers 41, 42 and mixed with the fuel cell stack cooling water is then pumped by pumps 67, 68 through passages 69, 70, and converges in the main passage 32. A control valve 72 is provided at the convergence portion of the passages 69, 70, and another control valve 73 is provided in the position where the passage following this convergence converges with the main passage 32. Hence, when the water recovered by the condensers 41, 42 is to be returned to the main passage, these control valves 72, 73 are operated as well as the pumps 67, 68.

After the water vapor has been recovered by the condensers 41, 42, the discharged hydrogen and discharged air are led through passages 14, 17 to the burner 75, where they are burned and discharged outside of the system.

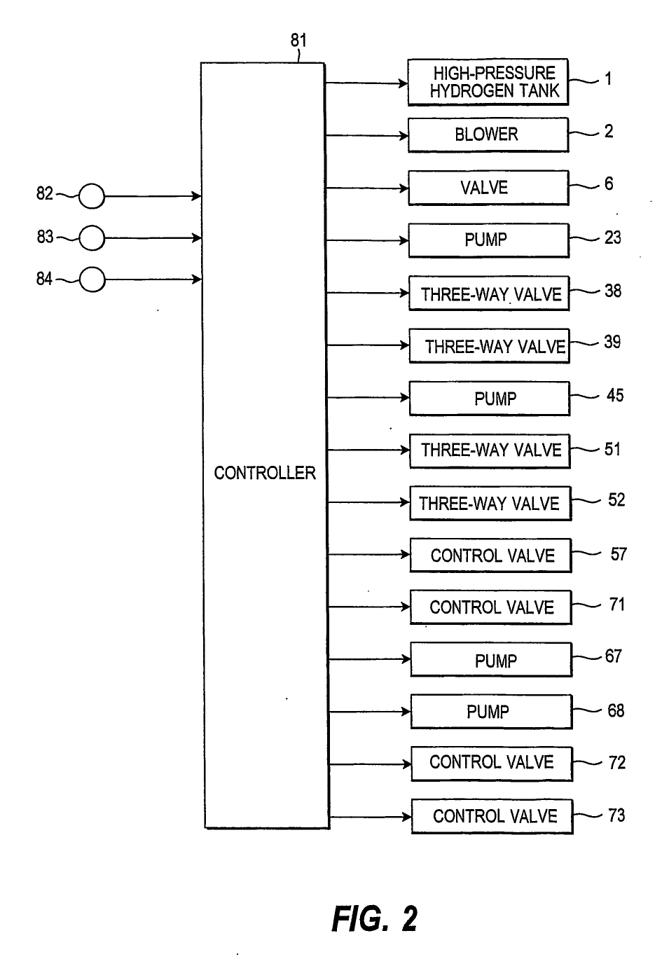

As shown in FIG. 2, the above-described high-pressure hydrogen tank 1, blower 2, valve 6, pump 23, three-way valves 38, 39, pump 45, three-way valves 51, 52, control valves 57, 71, pumps 67, 68, and control valves 72, 73 are all controlled by the controller 81. The ambient temperature of the condensers 41, 42, which is detected by a temperature sensor 82, and the antifreeze concentration of the fuel cell stack cooling water in the first cooling water tank 22, which is detected by an antifreeze concentration sensor 83, are input into the controller 81 together with a load condition of the movable body, which is detected by a load sensor 84.

The controller 81 controls the high-pressure hydrogen tank 1 and blower 2 to ensure that the fuel cell stack 5 is supplied with hydrogen and air in amounts corresponding to the load condition detected by the load sensor 84, or in other words the output demand of the movable body.

On the basis of the ambient temperature of the condensers 41, 42, detected by the temperature sensor 82, a determination is made in the controller 81 as to whether or not to perform water recovery while introducing fuel cell stack cooling water from the injectors 61, 62. Furthermore, on the basis of the antifreeze concentration detected by the antifreeze concentration sensor 83, the controller 81 controls the control valve 57 to ensure that the antifreeze concentration of the cooling water in the first cooling water tank 22 does not exceed the predetermined value.

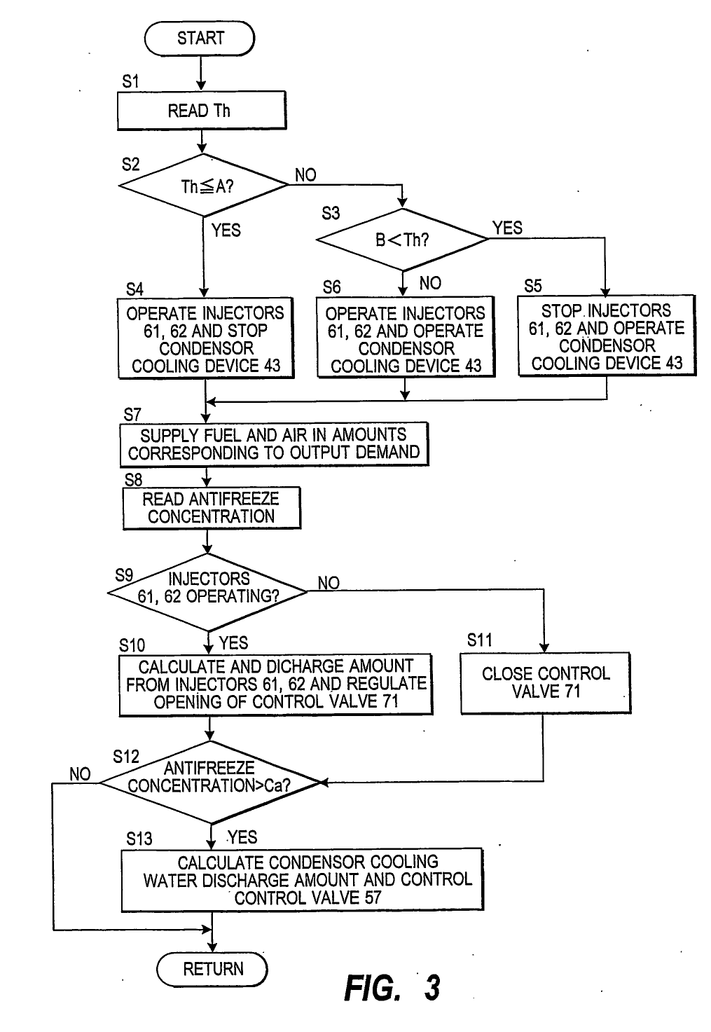

FIG. 3 shows the content of the control performed by the controller 81. This flow is executed in the controller 81 at fixed time intervals.

In a step S1, an ambient temperature Th of the condensers 41, 42, detected by the temperature sensor 82, is read.

In steps S2, S3, the ambient temperature Th is compared with predetermined values A, B to determine whether the ambient temperature Th is located within any of the following temperature regions.
Th≦A (1)
B<Th (2)
A<Th≦B (3)

The predetermined value A is set as an upper temperature limit (for example, −5° C.) at which the water vapor contained in the exhaust gas from the fuel cell stack 5 freezes within the condensers 41, 42. In other words, (1) is a temperature region in which the water vapor contained in the exhaust gas freezes within the condensers 41, 42, and hence to prevent this freezing, the routine advances to a step S4, where the injectors 61, 62 are operated.

Also at this time, the pump 45 is halted to stop the condenser cooling device 43 from operating. The reason for doing so is that when the ambient temperature is low enough for the water vapor in the exhaust gas to freeze inside the condensers 41, 42, there is no need to operate the condenser cooling device 43 to cool the condensers 41, 42.

Meanwhile, the predetermined value B is set to a lower temperature limit (+5° C.) at which the water vapor contained in the exhaust gas does not freeze within the condensers 41, 42. In other words, when (2) applies, the condensed water does not freeze in the interior of the condensers 41, 42, and hence there is no need to spray fuel cell stack cooling water from the injectors 61, 62. Therefore, the routine advances to a step S5, where the injectors 61, 62 are made inoperative. Also at this time, the pump 45 is activated to operate the condenser cooling device 43, and the three-way valves 51, 52 are switched so that the condenser cooling water flows through the radiator 46.

(3) is a temperature region in which the ambient temperature Th of the condensers 41, 42 is in the vicinity of zero degrees centigrade. If the condenser cooling device 43 is operated to cool the condensers 41, 42 immediately after the ambient temperature of the condensers 41, 42 rises beyond the predetermined value A as an operation of the fuel cell system continues, there is a possibility that the condensers 41, 42 may be cooled to the extent that the condensed water freezes partially in the interior of the condensers 41, 42, since the temperature of the condenser cooling water is low. Accordingly, in the temperature region (3), the injectors 61, 62 are operated while operating the condenser cooling device 43 to prevent this partial freezing.

In a step S7, the valve 6 and the blower 2 are controlled on the basis of the load detected by the load sensor 84 to supply hydrogen and air to the fuel cell stack 5 in amounts corresponding to the output demand of the fuel cell system. In a step S8, the antifreeze concentration of the cooling water in the cooling water tank 22, detected by the antifreeze concentration sensor 83, is read.

In a step S9, when the result of a determination as to whether or not the injectors 61, 62 are operating is positive (when the routine advances through the steps S4, S6), the routine advances to a step S10, where the discharge amount from the injectors 61, 62 is calculated on the basis of the antifreeze concentration, and the opening of the control valve 71 is regulated such that the calculated discharge amount is discharged from the injectors 61, 62.

When the injectors 61, 62 are not operating (when the routine advances through the step S5), the routine advances from the step S9 to a step S11, where the control valve 71 is closed completely to prevent the fuel cell stack cooling water from flowing into the bifurcated passage 63 from the main passage 31.

In a step S12, the antifreeze concentration is compared with the predetermined concentration Ca. The predetermined concentration Ca is the upper antifreeze concentration limit. When the antifreeze concentration is equal to or less than the predetermined concentration Ca, the current routine ends with no further processing.

The hydrogen and air supplied to the fuel cell stack 5 are humidified by the humidifiers 3, 4, and hence the fuel cell stack cooling device 21 is deprived of the water that is consumed in the humidification. As a result, the antifreeze concentration in the first cooling water tank 22 increases relatively. If the operation of the fuel cell system continues, the antifreeze concentration eventually exceeds the predetermined concentration Ca, and hence at this time, the routine advances from the step S12 to a step S13, where the amount of condenser cooling water (the antifreeze concentration of which is unchanging regardless of the fuel cell system operation) to be discharged from the second cooling water tank 44 to the first cooling water tank 22 is calculated. The control valve 57 is then controlled such that the calculated discharge amount of condenser cooling water is led to the first cooling water tank 22, whereby the antifreeze concentration of the cooling water in the first cooling water tank 22 returns to or below the predetermined concentration Ca.

The actions of this embodiment will now be described.

This embodiment employs a method of melting point reduction whereby in the water recovery device, the freezing point (melting point) of the solution is reduced below that of the solvent (pure water). More specifically, in this embodiment the water recovery device is constituted by the condensers 41, 42, in which the fuel cell stack cooling water is used to condense the water vapor contained in the exhaust gas into water, and comprises the injectors 61, 62 (liquid introducing mechanism) which introduce the fuel cell stack cooling water serving as a water-compatible liquid into the space in which the water vapor contained in the exhaust gas is condensed into water.

Exhaust gas containing water vapor is discharged from the fuel cell stack 5 and enters the condensers 41, 42. In the interior of the condensers 41, 42, the water vapor in the exhaust gas is condensed, whereupon the resultant condensed water is dissolved into the fuel cell stack cooling water (water-compatible liquid) introduced by the injectors 61, 62 to form a solution. The freezing point of the solution decreases below zero degrees centigrade, which is the freezing point of pure water, and hence the condensed water inside the condensers 41, 42 is prevented from freezing even when the ambient temperature of the condensers is below freezing point.

The constitution of the injectors 61, 62 serving as a liquid introducing mechanism is simple, and hence condensed water can be prevented from freezing below freezing point by means of a simple constitution. Moreover, there is no need to provide a heater or burner to warm the condensers, and hence energy loss due to warming performed every time the fuel cell system is started up does not occur.

The fuel cell stack cooling device 21 is provided, and the fuel cell stack cooling water is used as a water-compatible liquid. In other words, there is no need to provide a separate tank for storing water-compatible liquid, and therefore the size of the fuel cell system can be reduced.

In a fuel cell system in which hydrogen is supplied directly from the high-pressure hydrogen tank 1, the hydrogen is usually humidified to prevent a polymer membrane within the fuel cell stack 5 from drying. Likewise in this embodiment, the hydrogen and air are humidified by the fuel cell stack cooling water. Hence the water recovered in the condensers 41, 42 can be used to humidify the hydrogen and air, and the fuel cell stack cooling water, which is reduced in concentration by the water recovery process, can be enriched by this humidification.

By further providing the first cooling water tank 22 for storing the fuel cell stack cooling water and the concentration sensor 83 for detecting the antifreeze concentration of the cooling water in the cooling water tank 22, and controlling the discharge amount from the injectors 61, 62, or in other words the amount of water condensed in the condensers 41, 42, on the basis of the detected antifreeze concentration (FIG. 3, step S10), the amount of water returned to the first cooling water tank 22 is regulated and the antifreeze concentration of the cooling water in the cooling water tank 22 is held at a constant level. Thus the antifreeze concentration when performing humidification and the antifreeze concentration when cooling the fuel cell stack 5 can be maintained at appropriate levels.

The antifreeze concentration of the cooling water in the first cooling water tank 22 is held within a fixed range by controlling the amount of water that is condensed from the exhaust gas discharged from the fuel cell stack 5, but if antifreeze escapes together with water vapor during humidification, then the amount of antifreeze decreases such that it may become impossible to hold the antifreeze concentration of the cooling water in the first cooling water tank 22 within the fixed range. According to this embodiment, the second cooling water tank 44 for storing condenser cooling water and the mechanism 56, 57 for causing cooling water from the second cooling water tank 44 to flow into the first cooling water tank 22 are provided, and the amount of condenser cooling water flowing into the first cooling water tank 22 is controlled on the basis of the antifreeze concentration of the cooling water in the first cooling water tank 22 (FIG. 3, steps S12, S13). Hence the antifreeze concentration can be adjusted in such cases.

When the ambient temperature Th of the condensers 41, 42 is high, the pressure of the exhaust gas discharged from the fuel cell stack 5 increases, and the water vapor becomes correspondingly likely to condense. Hence in this case, it is not always necessary to introduce the water-compatible liquid. In this embodiment, the temperature sensor 82 is provided to detect the ambient temperature Th of the condensers 41, 42, and control is performed on the basis of the ambient temperature Th to introduce or stop the water-compatible liquid, or in other words to operate or halt the injectors 61, 62, as shown in the steps S1-S6 of FIG. 3. Hence, unnecessary introduction of the water-compatible liquid can be prevented by stopping the introduction of the water-compatible liquid when the ambient temperature Th of the condensers 41, 42 is high.

If the amount of introduced water-compatible liquid is small in relation to the amount of water vapor when the water vapor in the exhaust gas discharged from the fuel cell stack 5 is to be condensed, then partial freezing of the condensed water may occur. To avoid this, the amount of introduced water-compatible liquid, or in other words the discharge amount from the injectors 61, 62, may be controlled in the step S10 on the basis of the amount of power generated by the fuel cell stack 5. For example, when there is a large amount of water vapor in the exhaust gas from the fuel cell stack 5, or in other words when the fuel cell stack 5 generates a large amount of power, partial freezing of the condensed water can be avoided by increasing the discharge amount from the injectors 61, 62 correspondingly.

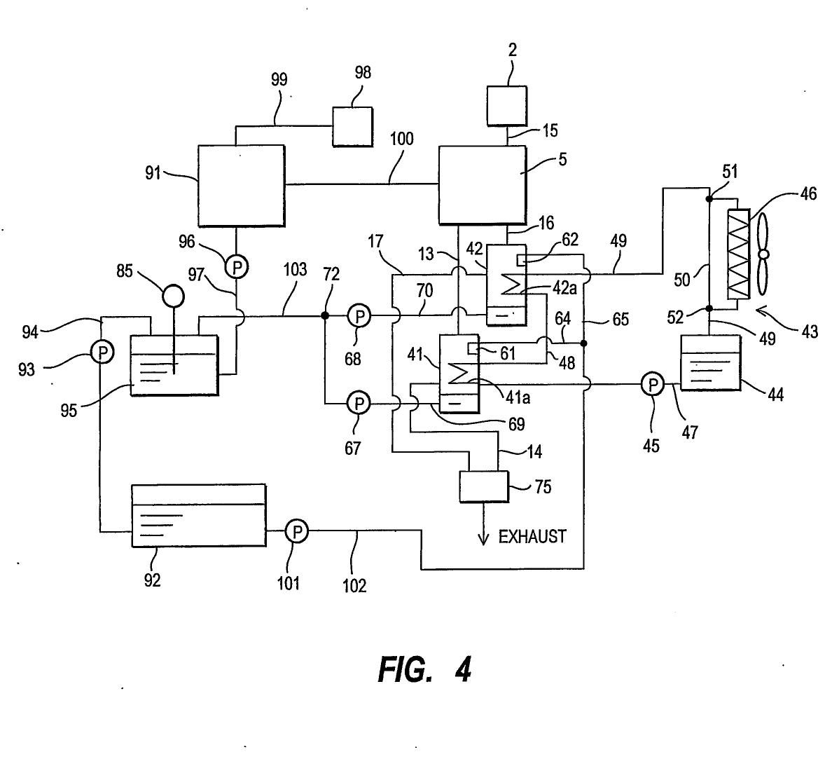

FIGS. 4-6 show a second embodiment. FIGS. 4-6 correspond to FIGS. 1-3 of the first embodiment. Identical reference symbols have been allocated to identical constitutions and processes to those of the first embodiment, and description thereof has been omitted.

Focussing mainly on the differences with the first embodiment, the fuel cell system shown in FIG. 4 is a fuel reforming fuel cell system which generates hydrogen by reforming methanol, which is an alcohol fuel, using a fuel reforming device 91, and supplies the generated hydrogen to the fuel cell stack 5.

The reforming fuel cell system will now be described. A device which supplies methanol and water to the fuel reforming device 91 is constituted by a methanol tank 92, a pump 93, a liquid mixture tank 95, and a pump 96. The methanol and water, which serve as the raw materials of the reformate gas, are pumped from the liquid mixture tank 95 by the pump 96 and supplied to the fuel reforming device 91 through a passage 97. The air that is used in the reforming process is supplied from a blower 98 to the fuel reforming device 91 through a passage 99. The hydrogen (reformate gas) generated in the fuel reforming device 91 is supplied to the fuel cell stack 5 together with air.

A liquid mixture of methanol and water is stored in the liquid mixture tank 95. Since the melting point of methanol is approximately −100° C., the liquid mixture of methanol and water (the liquid reforming material) does not freeze at normal ambient temperatures, and hence the fuel cell system can be started up using this liquid reforming material even in cold regions.

In the reforming fuel cell system constituted as described above, the water recovery device is constituted similarly to the first embodiment by the condensers 41, 42, the condenser cooling device 43, and the injectors 61, 62.

However, methanol from the methanol tank 92 is pumped through a passage 102 to the injectors 61, 62 by a pump 101, and this methanol is sprayed onto the exhaust gas in the interior of the condensers 41, 42 by the injectors 61, 62. The water vapor contained in the exhaust gas mixes with the methanol from the injectors 61, 62 in the condensers 41, 42 while being cooled by the condenser cooling device 43 so as to condense, and thus gathers in the bottom of the condensers 41, 42.

The condensed water mixed with the methanol is a water-compatible solution, and accordingly, the melting point of this solution falls below zero degrees centigrade, which is the melting point of pure water. Hence in the second embodiment also, condensed water can be prevented from freezing below freezing point.

The control valve 72 is provided at the convergence portion of the two passages 69, 70 opening from the bottom of the condensers 41, 42. By controlling the control valve 72 as the pumps 67, 68 are operated, the water recovered by the condensers 41, 42 is returned to the liquid mixture tank 95 through a passage 103.

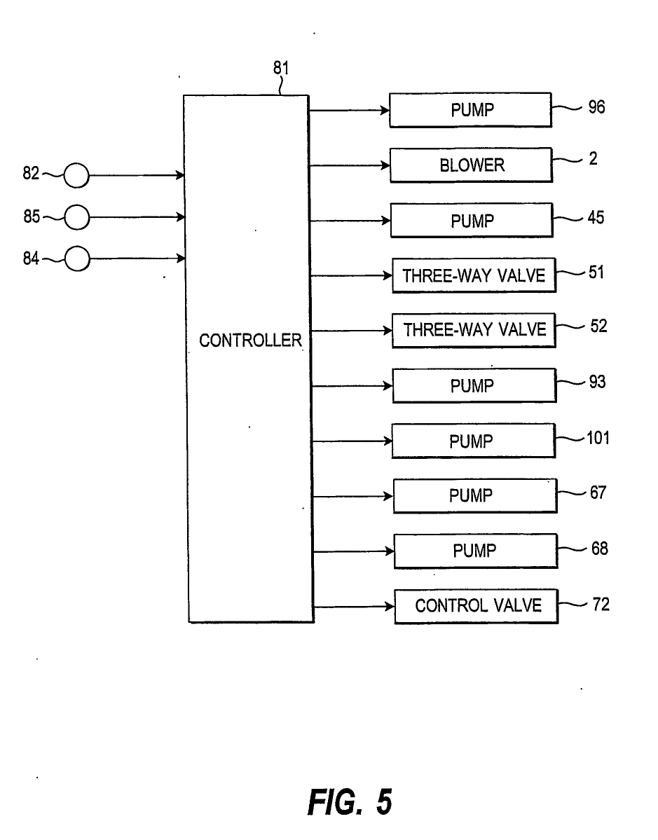

As shown in FIG. 5, the ambient temperature Th of the condensers 41, 42, which is detected by the ambient temperature sensor 82, and the methanol concentration of the liquid mixture in the liquid mixture tank 95, which is detected by a methanol concentration sensor 85, are input into the controller 81 together with a load condition of the movable body, which is detected by the load sensor 84. Thus the above-described pump 96, blower 2, pump 45, three-way valves 51, 52, pumps 93, 101, 67, 68, and control valve 72 are controlled by the controller 81.

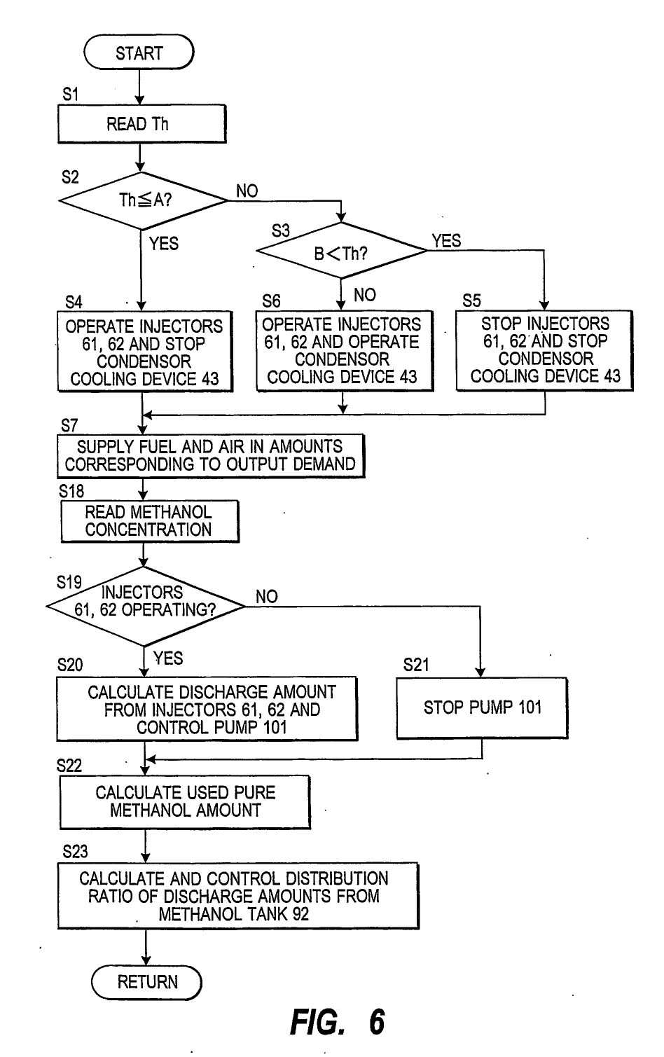

FIG. 6 shows the content of the control performed by the controller 81. The steps S1-S7 are identical to those of the first embodiment.

Focussing mainly on the differences with the first embodiment, in a step S18, the methanol concentration of the liquid mixture in the liquid mixture tank 95, detected by the methanol concentration sensor 85, is read.

In a step S19, when the result of a determination as to whether or not the injectors 61, 62 are operating is positive (when the routine advances through the steps S4, S6), the routine advances to a step S20, where the pump 101 is operated, the discharge amount from the injectors 61, 62 is calculated on the basis of the methanol concentration, and the pump 101 is controlled such that the calculated discharge amount is discharged from the injectors 61, 62. By regulating the discharge amount from the injectors 61, 62, the amount of water that is condensed can be regulated, and hence the amount of water returned to the liquid mixture tank 95 can be regulated. Thus the methanol concentration of the liquid mixture in the liquid mixture tank is held at a fixed level.

When the injectors 61, 62 are not operating (when the routine advances through the step S5), the routine advances from the step S19 to a step S21, where the pump 101 is stopped.

In a step S22, the amount of pure methanol used in the reforming process is calculated from the amounts of hydrogen and air corresponding to the output demand of the fuel cell system.

In a step S23, the distribution ratio of the two discharge amounts from the methanol tank 92 (the discharge amount of the pump 101 and the discharge amount of the pump 93) is calculated in accordance with the methanol concentration such that the calculated used amount of pure hydrogen is supplied to the liquid mixture tank 95 from the methanol tank 92. The pumps 101, 93 are then controlled so as to discharge amounts corresponding to the calculated distribution ratio (methanol concentration correction).

To prevent the generation of unreacted substances such as methanol gas or carbon monoxide in the fuel reforming device 91, the mixing ratio of the water and methanol, or in other words the methanol concentration, is held at a predetermined concentration Cb by this methanol concentration correction. The predetermined concentration Cb differs according to the constitutional elements or performance of the system, and the fuel type.

In actuality, while the liquid mixture in the liquid mixture tank 95 is consumed through supply to the fuel reforming device 91, methanol from the methanol tank 92 and recovered water mixed with methanol from the condensers 41, 42 flow into the liquid mixture tank 95, and hence the methanol concentration of the liquid mixture in the liquid mixture tank 95 varies, causing the methanol concentration to exceed or fall below its predetermined allowable range.

Methanol from the methanol tank 92 is supplied through the two passages 102 and 94, and hence by increasing the discharge amount through one of the passages 94 such that the discharge amount through the other passage 102 decreases correspondingly, the methanol concentration of the liquid mixture tank 95 rises, and conversely, by decreasing the discharge amount from the passage 94 such that the discharge amount from the passage 102 increases correspondingly, the methanol concentration of the liquid mixture tank 95 falls.

Therefore, the pumps 93, 101 are controlled such that when the actual methanol concentration falls below its allowable range, the discharge amount flowing through the passage 94 increases and the discharge amount flowing through the passage 102 decreases accordingly, and when the actual methanol concentration exceeds its allowable range, the discharge amount flowing through the passage 94 decreases and the discharge amount flowing through the passage 102 increases accordingly.

More specifically, in cases when an excessive amount of water is recovered from the exhaust gas in the condensers 41, 42 during the low-temperature initial start-up stage of the fuel cell system, causing the methanol concentration of the liquid mixture tank 95 to fall, the discharge amount of the pump 101 is reduced such that the discharge amount of the pump 93 increases correspondingly, and thus the methanol concentration of the liquid mixture tank 95 is increased. Needless to say, when the injectors 61, 62 must be operated to prevent the condensed water in the interior of the condensers 41, 42 from freezing in accordance with the original object of this invention, or in other words when the control routine passes through the steps S4, S6, the discharge amount of the pump 101 is set to a predetermined minimum level such that the discharge amount of the pump 101 does not fall any further.

When the injectors 61, 62 do not need to be operated (when the control routine passes through the step S5), the discharge amount of the pump 101 is set to zero, and the discharge amount of the pump 93 is set such that the pure methanol amount calculated in the step S22 is supplied through the passage 94 alone.

When a cold operation of the fuel cell system continues and the liquid mixture tank 95 is replenished from the methanol tank 92 with only the same amount of methanol as that consumed by the liquid mixture tank 95, the methanol concentration of the liquid mixture tank 95 falls below its allowable range. In such a case, the discharge amount of the pump 93 is further increased.

In the second embodiment, the water recovery device is constituted by the condensers 41, 42, in which the liquid mixture of water and methanol is used to condense the water vapor contained in the exhaust gas into water, and comprises the injectors 61, 62 which introduce the methanol serving as a water-compatible liquid into the space in which the water vapor in the exhaust gas is condensed into water. Exhaust gas containing water vapor is discharged from the fuel cell stack 5 and enters the condensers 41, 42, and in the interior of the condensers 41, 42, the water vapor in the exhaust gas is condensed. The resultant condensed water then dissolves into the methanol introduced through the injectors 61, 62 to form a solution. The melting point of the solution is below zero degrees centigrade, which is the melting point of pure water, and hence the condensed water is prevented from freezing inside the condensers 41, 42.

In the second embodiment, the fuel gas supply device is constituted by the fuel tank 92, pump 93, passage 94, liquid mixture tank 95, pump 96, passage 97, and fuel reforming device 91, and uses methanol from the fuel tank 92 as a water-compatible liquid. In the second embodiment, there is no need to provide a separate tank for storing a water-compatible liquid, and hence the fuel cell system can be reduced in size. It should be noted that the liquid mixture of water and methanol from the liquid mixture tank 95 may also be used as a water-compatible liquid.

Since the liquid which gathers in the condensers 41, 42 is also a liquid mixture of water and methanol, this liquid which gathers in the condensers 41, 42 is returned to the liquid mixture tank 95. Thus the liquid which gathers in the condensers 41, 42 may be used without modification as reforming fuel.

The discharge amount from the injectors 61, 62, or in other words the amount of condensed water in the condensers 41, 42 and the amount of water to be returned to the liquid mixture tank 95, is controlled on the basis of the methanol concentration of the liquid mixture tank 95. As a result, the methanol concentration of the liquid mixture tank 95 can be held at a predetermined value, and a ratio S/C of the water vapor amount to the fuel amount in the fuel reforming device 91 can be set to an appropriate value.

According to the second embodiment, the pump 93 and passage 94 are provided to introduce methanol from the methanol tank 92 into the liquid mixture tank 95. By controlling the amount of introduced methanol on the basis of the methanol concentration, the value of the ratio S/C of the water vapor amount to the fuel amount can be controlled during an operation of the fuel cell system. Hence, when the ratio S/C is to be lowered, for example, the ratio S/C can be lowered smoothly.

In the descriptions of the first and second embodiments, the water recovery device is a condenser in which water vapor contained in the exhaust gas is condensed into water by cooling water, and the injectors 61, 62 are provided to introduce a water-compatible liquid into the space in which the water vapor in the exhaust gas is condensed into water. However, the water recovery device may be constituted by a water separator which separates the water vapor from the exhaust gas, and the injectors 61, 62 may be constituted so as to introduce the water-compatible liquid into the space in which the water vapor is separated from the exhaust gas.

In the first embodiment, the antifreeze concentration of the cooling water in the first cooling water tank 22 is detected by the sensor 83, but instead, the antifreeze content may be detected. Alternatively, the antifreeze content or antifreeze concentration may be estimated rather than detected.

In the second embodiment, the liquid supplied to the injectors 61, 62 is methanol, but a liquid mixture of water and methanol may be used instead.

Embodiments of this invention were described above, but this invention is not limited to these embodiments. For example, the second embodiment may be modified such that the water recovery device is constituted by a tank containing a liquid mixture of water and methanol. In this case, water recovery can be performed below freezing point by bubbling the exhaust gas from the fuel cell stack 5 into the liquid mixture in the liquid mixture tank.

Further, methanol is used as the reforming fuel, but ethanol may be used as a similar alcohol material.

The entire contents of Japanese Patent Application P2003-374264 (filed Nov. 4, 2003) are incorporated herein by reference.

Although the invention has been described above by reference to a certain embodiment of the invention, the invention is not limited to the embodiment described above. Modifications and variations of the embodiments described above will occur to those skilled in the art, in the light of the above teachings. The scope of the invention is defined with reference to the following claims.

### INDUSTRIAL APPLICABILITY

This invention can be applied to a fuel cell system, and is useful for preventing water in the fuel cell from freezing in order to expand the outside air temperature range in which the fuel cell system is operable. Further, this invention is not limited to a fuel cell system for use in a movable body, and may also be applied to a stationary fuel cell system.

1-12. (canceled)

13. A fuel cell system comprising:
a fuel gas supply mechanism which supplies a fuel gas;
an oxidizing gas supply mechanism which supplies an oxidizing gas;
a fuel cell which generates power using the fuel gas supplied from the fuel gas supply mechanism and the oxidizing gas supplied from the oxidizing gas supply mechanism; and
a water recovery device which recovers water contained in an exhaust gas from the fuel cell, the water recovery device including a liquid introducing mechanism which sprays a water-compatible liquid onto a location where the water is recovered by the water recovery device.

14. The fuel cell system as defined in claim 13, further comprising a cooling device which cools the fuel cell using a cooling water-antifreeze mixture,
wherein the cooling water-antifreeze mixture for cooling the fuel cell is used as the water-compatible liquid.

15. The fuel cell system as defined in claim 14, wherein the fuel gas supply mechanism is a device which stores hydrogen, and
the system further comprises a humidifier which humidifies at least one of the fuel gas and the oxidizing gas using the cooling water-antifreeze mixture for cooling the fuel cell.

16. The fuel cell system as defined in claim 16, comprising:
a first cooling water tank which stores the cooling water-antifreeze mixture for cooling the fuel cell; and
a controller which controls an amount of water recovered by the water recovery device on the basis of an antifreeze concentration of the first cooling water tank.

17. The fuel cell system as defined in claim 16, comprising:
a second cooling water tank which stores the cooling water-antifreeze mixture for cooling the water recovery device; and
a flow control mechanism which introduces the cooling water-antifreeze mixture in the second cooling water tank into the first cooling water tank,
wherein the controller controls an amount of cooling water-antifreeze mixture to be introduced into the first cooling water tank from the second cooling water tank via the flow control mechanism in accordance with the antifreeze concentration of the cooling water-antifreeze mixture in the first cooling water tank.

18. The fuel cell system as defined in claim 13, wherein the fuel gas supply mechanism comprises:
a fuel tank which stores a fuel;
a fuel supply mechanism which supplies the fuel from the fuel tank;
a liquid mixture tank which stores a liquid mixture of water and the supplied fuel;
a liquid mixture supply mechanism which supplies the liquid mixture of water and fuel from the liquid mixture tank; and
a fuel reforming device which generates a reformate gas containing hydrogen by reforming the fuel from the supplied liquid mixture of water and fuel, and
either one of the fuel from the fuel tank and the liquid mixture of water and fuel from the liquid mixture tank is used as the water-compatible liquid.

19. The fuel cell system as defined in claim 18, wherein the water recovered by the water recovery device is returned to the liquid mixture tank.

20. The fuel cell system as defined in claim 19, further comprising a controller which controls the amount of water recovered by the water recovery device on the basis of a fuel concentration of the liquid mixture in the liquid mixture tank.

21. The fuel cell system as defined in claim 20, comprising a flow control mechanism which introduces the fuel from the fuel tank into the liquid mixture tank,
wherein the controller controls an amount of fuel to be introduced into the liquid mixture tank from the fuel tank via the flow control mechanism on the basis of the fuel concentration of the liquid mixture tank.

22. The fuel cell system as defined in claim 13, wherein the controller controls an amount of water-compatible liquid to be sprayed from the liquid introducing mechanism onto the location where the water is recovered from the exhaust gas on the basis of an ambient temperature of the water recovery device.

23. The fuel cell system as defined in claim 22, wherein the controller controls the amount of water-compatible liquid to be sprayed from the liquid introducing mechanism onto the location where the water is recovered from the exhaust gas on the basis of an amount of power generated by the fuel cell.

24. A fuel cell system comprising:
a fuel gas supply means for supplying a fuel gas;
an oxidizing gas supply means for supplying an oxidizing gas;
a fuel cell which generates power using the fuel gas supplied from the fuel gas supply means and the oxidizing gas supplied from the oxidizing gas supply means; and
a water recovery device means for recovering water contained in an exhaust gas from the fuel cell, the water recovery means including a liquid introducing means for spraying a water-compatible liquid onto a location where the water is recovered by the water recovery device.

25. A water recovery method for a fuel cell system having a fuel gas supply mechanism which supplies a fuel gas, an oxidizing gas supply mechanism which supplies an oxidizing gas, and a fuel cell which generates power using the fuel gas supplied from the fuel gas supply mechanism and the oxidizing gas supplied from the oxidizing gas supply mechanism, the method comprising:
recovering water contained in an exhaust gas from the fuel cell, and
spraying a water-compatible liquid onto a location where the water is recovered.
